(19) United States
(12) Patent Application Publication
(10) Pub. No.: US 2025/0329749 A1
(43) Pub. Date: Oct. 23, 2025

(54) COMPOSITE SUBSTRATE FOR RECHARGEABLE LITHIUM BATTERY AND RECHARGEABLE LITHIUM BATTERY INCLUDING THE SAME

(71) Applicant: SAMSUNG SDI CO., LTD., Gyeonggi-do (KR)

(72) Inventor: Hyunwoo KIM, Gyeonggi-do (KR)

(73) Assignee: SAMSUNG SDI CO., LTD., Gyeonggi-do (KR)

(21) Appl. No.: 18/923,046

(22) Filed: Oct. 22, 2024

(30) Foreign Application Priority Data
Apr. 23, 2024 (KR) 10-2024-0053733

(51) Int. Cl. H01M 4/66; H01M 4/02; H01M 4/04; H01M 4/80; H01M 10/0525

(52) U.S. Cl. CPC H01M 4/667; H01M 4/0435; H01M 4/0466; H01M 4/661; H01M 4/668; H01M 4/806; H01M 10/0525; H01M 2004/021

(57) ABSTRACT

Disclosed are composite substrates and rechargeable lithium batteries. The composite substrate includes a first metal layer, a second metal layer, and a fiber mat layer between the first metal layer and the second metal layer. The fiber mat layer includes a plurality of fibers and a plurality of voids between the plurality of fibers. The composite substrate has a first surface on which the first metal layer is formed, and a second surface on which the second metal layer is formed. An average roughness (Sa) of the first surface is in a range of about 1 μm to about 3 μm.

### CROSS-REFERENCE TO RELATED APPLICATION

This U.S. nonprovisional application claims priority under 35 U.S.C § 119 to Korean Patent Application No. 10-2024-0053733 filed on Apr. 23, 2024 in the Korean Intellectual Property Office, the disclosure of which is hereby incorporated by reference in its entirety.

### BACKGROUND

The present disclosure relates to a composite substrate for a rechargeable lithium battery, and a rechargeable lithium battery including the composite substrate.

With the increased spread of battery-using electronic devices, such as, e.g., mobile phones, laptop computers, electric vehicles, and the like, there is increasing demand for rechargeable batteries with high energy density and high capacity.

A rechargeable lithium battery typically includes a positive electrode, a negative electrode, and an electrolyte, the positive and negative electrodes including an active material in which intercalation and deintercalation are possible, and the battery generates electrical energy caused by oxidation and reduction reactions when lithium ions are intercalated and deintercalated.

### SUMMARY

An example embodiment of the present disclosure include a composite substrate having a high electrical conductivity and a desired or improved adhesion force to an active material layer.

An example embodiment of the present disclosure include a rechargeable lithium battery including the composite substrate.

According to an example embodiment of the present disclosure, a composite substrate for a rechargeable lithium battery may include a first metal layer, a second metal layer, and a fiber mat layer between the first metal layer and the second metal layer. The fiber mat layer may include a plurality of fibers, and a plurality of voids between the plurality of fibers. The composite substrate may have a first surface on which the first metal layer is exposed, and a second surface on which the second metal layer is exposed. An average roughness (Sa) of the first surface may be in a range of about 1 μm to about 3 μm.

According to an example embodiment of the present disclosure, a rechargeable lithium battery may include a composite substrate that includes a first metal layer, a second metal layer, and a fiber mat layer between the first and second metal layers, and a battery cell on the first metal layer. The fiber mat layer may include a plurality of fibers, and a plurality of voids between the plurality of fibers. A porosity of the fiber mat layer may be in a range of about 30% to about 70%.

According to an example embodiment of the present disclosure, a method of manufacturing a composite substrate may include electrospinning a precursor to form a fiber mat layer, forming a stack structure in which the fiber mat layer is between a first metal layer and a second metal layer, and rolling the stack structure.

### BRIEF DESCRIPTION OF DRAWINGS

FIG. 1 is a simplified conceptual diagram illustrating a rechargeable lithium battery according to an example embodiment of the present disclosure.

FIGS. 2 to 5 are simplified diagrams illustrating a rechargeable lithium battery according to an example embodiment of the present disclosure.

FIG. 6 is a cross-sectional view illustrating a rechargeable lithium battery according to an example embodiment of the present disclosure.

FIG. 7 is a cross-sectional view illustrating a composite substrate according to a comparative example of the present disclosure.

FIG. 8A is a perspective view illustrating a composite substrate according to an example embodiment of the present disclosure.

FIG. 8B is a cross-sectional view illustrating a fiber of FIG. 8A.

FIG. 9 is a cross-sectional view taken along line A-A′ of FIG. 8A, illustrating a composite substrate according to an example embodiment of the present disclosure.

FIGS. 10 and 11 are cross-sectional views taken along line A-A′ of FIG. 8A, illustrating a composite substrate according to an example embodiment of the present disclosure.

FIG. 12 is a conceptual diagram illustrating an electrospinning apparatus for manufacturing a fiber mat layer according to an example embodiment of the present disclosure.

FIG. 13 is a perspective view illustrating a fiber mat layer according to an example embodiment of the present disclosure.

FIGS. 14 and 15 are cross-sectional views taken along line A-A′ of FIG. 13, illustrating a method of manufacturing a composite substrate according to an example embodiment of the present disclosure.

### DETAILED DESCRIPTION OF EXAMPLE EMBODIMENTS

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it will be understood that, when an element is referred to as being “on” another element, the element can be directly on the other element or intervening elements may be present between therebetween. In the drawings, thicknesses of some components are exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

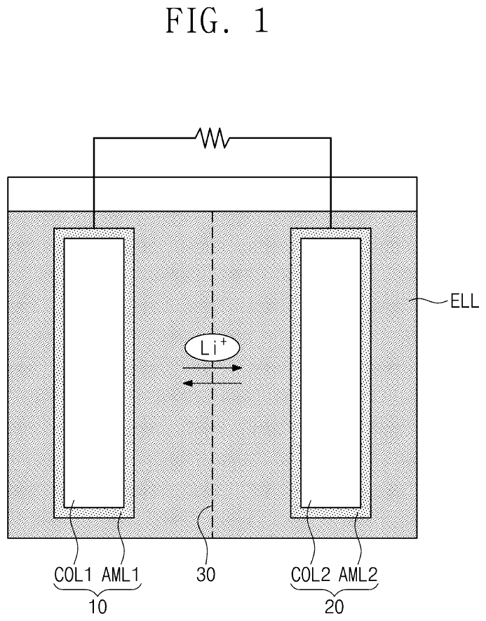

FIG. 1 is a simplified conceptual diagram illustrating a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be located between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte solution ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material, and may further include a binder and/or a conductive material.

For example, the positive electrode 10 may further include an additive that can constitute a sacrificial positive electrode.

An amount of the positive electrode active material may be about 90 wt % to about 99.5 wt % relative to 100 wt % of the positive electrode active material layer AML1. An amount of each, or at least one, of the binder and the conductive material may be about 0.5 wt % to about 5 wt % relative to 100 wt % of the positive electrode active material layer AML1.

The binder may improve attachment of positive electrode active material particles to each other and also to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause chemical change of a battery may constitute the conductive material to constitute the battery. The conductive material may include, for example, at least one of a carbon-based material such as natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be included in the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may improve attachment of negative electrode active material particles to each other, and also to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material that does not cause chemical change of a battery may constitute the conductive material to constitute the battery. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, at least one of crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOx (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, and a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be used in combination with a carbon-based negative electrode active material.

### Separator 30

Based on type of the rechargeable lithium battery, the separator 30 may be between positive electrode 10 and the negative electrode 20. The separator 30 may include one or more of polyethylene, polypropylene, and polyvinylidene fluoride, and may have a multilayered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, the coating layer including an organic material, an inorganic material, or a combination thereof.

The porous substrate may be or include a polymer layer including a polyolefin such as or including at least one of polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle that includes at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be formed as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more solvents.

In addition, when a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be or include a material that is dissolved in the non-aqueous organic solvent to constitute a supply source of lithium ions in a battery and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, liN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato)borate (LiBOB)

### Rechargeable Lithium Battery

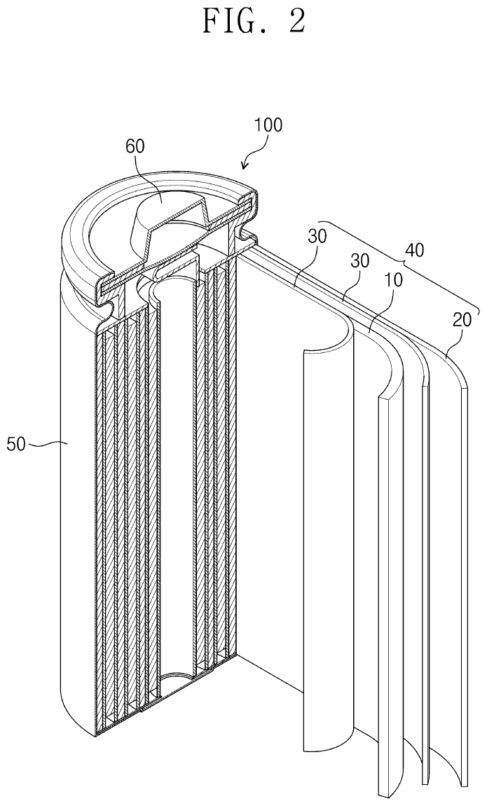

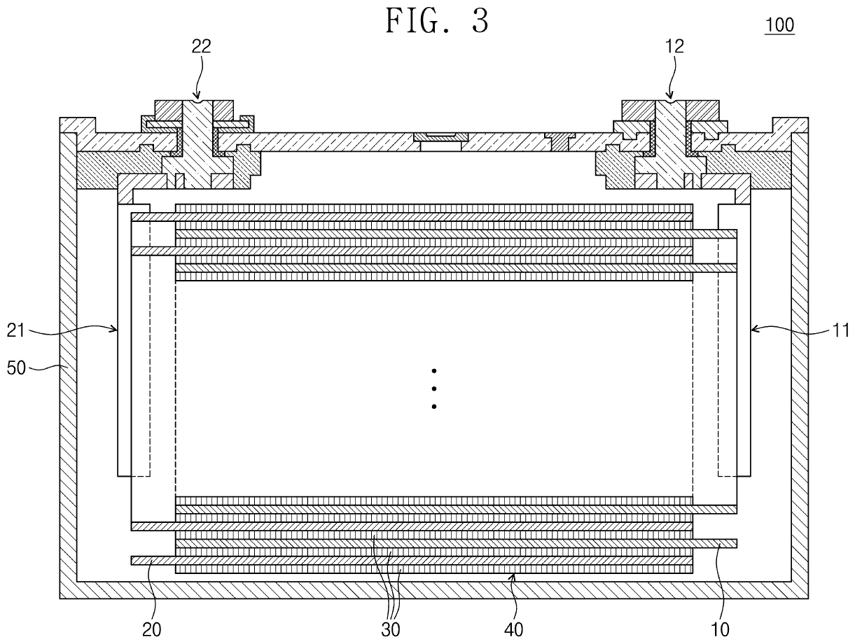

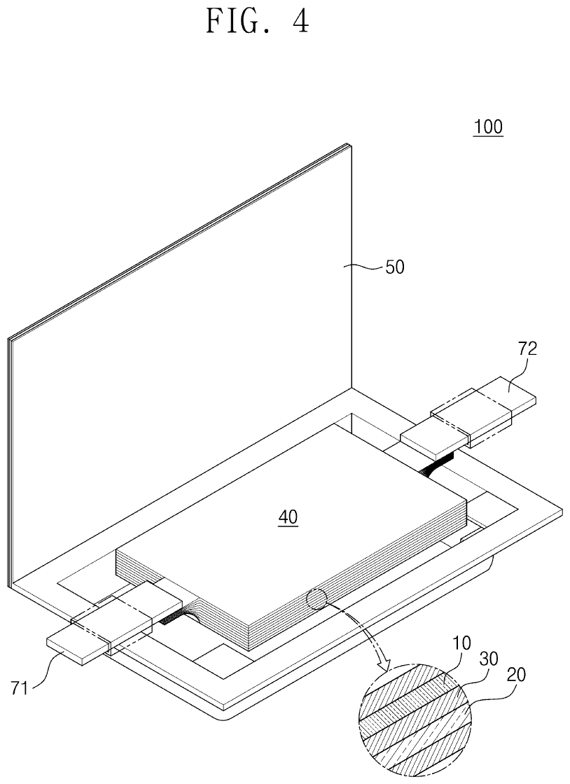

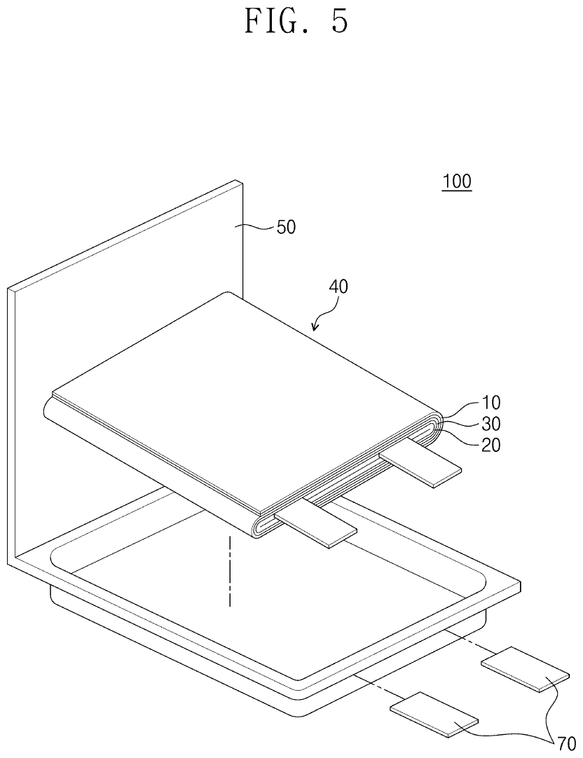

Based on the shape of a rechargeable lithium battery, the rechargeable lithium battery may be classified into cylindrical, prismatic, pouch, and coin types. FIGS. 2 to 5 are simplified diagrams illustrating a rechargeable lithium battery according to an example embodiment, FIG. 2 illustrating a cylindrical battery, FIG. 3 illustrating a prismatic battery, and FIGS. 4 and 5 illustrating pouch-type batteries. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tab 70/71/72 constituting an electrical path for externally inducing a current generated in the electrode assembly 40.

In the example embodiments that follow, a detailed description of technical features repetitive to those of the rechargeable lithium battery discussed with reference to FIGS. 1 to 5 will be omitted, and a difference thereof will be discussed in detail.

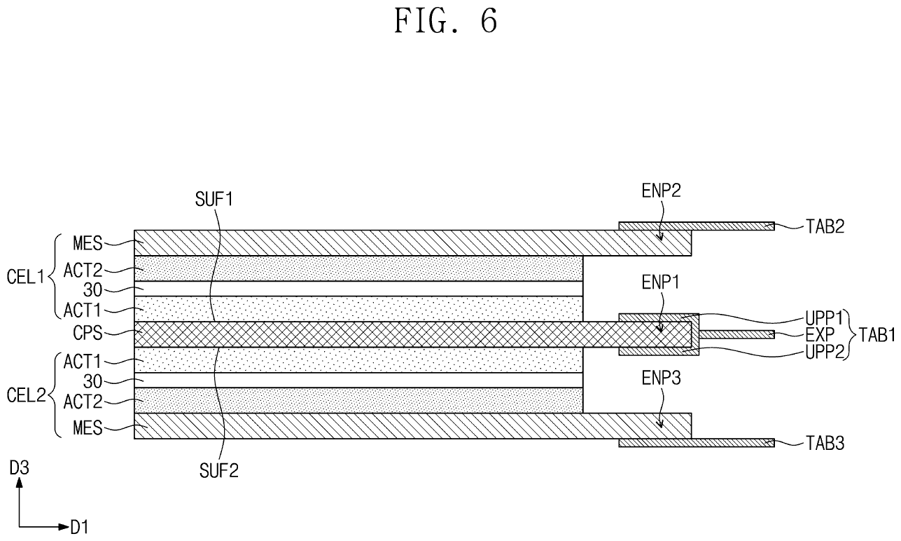

FIG. 6 is a cross-sectional view illustrating a rechargeable lithium battery according to an example embodiment of the present disclosure. FIG. 6 illustrates a composite substrate CPS, a first battery cell CEL1 on a first surface SUF1 of the composite substrate CPS, and a second battery cell CEL2 on a second surface SUF2 of the composite substrate CPS. The first battery cell CEL1 and the second battery cell CEL2 may stand opposite to each other in a third direction D3.

A single bi-cell may be constituted by the first battery cell CEL1, the second battery cell CEL2, and the composite substrate CPS of FIG. 6 therebetween. The first battery cell CEL1, the second battery cell CEL2, and the composite substrate CPS of FIG. 6 may constitute the electrode assembly 40 discussed above with reference to FIGS. 2 to 5.

Each, or at least one, of the first battery cell CEL1 and the second battery cell CEL2 may include a first active material layer ACT1, a separator 30, a second active material layer ACT2, and a metal substrate MES. The first active material layer ACT1 may be formed on the composite substrate CPS. The second active material layer ACT2 may be separated from the first active material layer ACT1 by the separator 30. The metal substrate MES may be formed on the second active material layer ACT2.

The first active material layer ACT1 may be one of the positive electrode active material layer AML1 and the negative electrode active material layer AML2 that are discussed above with reference to FIG. 1. The second active material layer ACT2 may be the other of the positive electrode active material layer AML1 and the negative electrode active material layer AML2 that are discussed above with reference to FIG. 1. In an example embodiment of the present disclosure, the first active material layer ACT1 may be or include the positive electrode active material layer AML1, and the second active material layer ACT2 may be or include the negative electrode active material layer AML2. The metal substrate MES may be the current collector COL1 or COL2 discussed above with reference to FIG. 1.

The composite substrate CPS may include a first end portion ENP1 at one end thereof. The metal substrate MES of the first battery cell CEL1 may include a second end portion ENP2 at one end thereof. The metal substrate MES of the second battery cell CEL2 may include a third end portion ENP3 at one end thereof.

A first tab TAB1 may be formed on the first end portion ENP1 of the composite substrate CPS. The first tab TAB1 may include a first connection portion UPP1, a second connection portion UPP2, and an extension portion EXP. The first connection portion UPP1 may be in contact with the first surface SUF1 of the composite substrate CPS. The second connection portion UPP2 may be in contact with the second surface SUF2 of the composite substrate CPS. The extension portion EXP may connect the first connection portion UPP1 and the second connection portion UPP2 to each other. The extension portion EXP may horizontally extend in a first direction D1 from the first end portion ENP1.

The first tab TAB1 may electrically connect the first surface SUF1 and the second surface SUF2 of the composite substrate CPS to each other. The first tab TAB1 may be configured to apply a voltage in common to the first surface SUF1 and the second surface SUF2 of the composite substrate CPS.

A second tab TAB2 may be formed on the second end portion ENP2 of the composite substrate CPS. The second tab TAB2 may be configured to apply a voltage to the metal substrate MES of the first battery cell CEL1. A third tab TAB3 may be formed on the third end portion ENP3 of the metal substrate MES. The third tab TAB3 may be configured to apply a voltage to the metal substrate MES of the second battery cell CEL2.

The first tab TAB1 may constitute one of positive and negative tabs (or positive and negative lead tabs) discussed above with reference to FIGS. 2 to 5. The second and third tabs TAB2 and TAB3 may constitute the other ones of the positive and negative tabs (or positive and negative lead tabs) discussed above with reference to FIGS. 2 to 5.

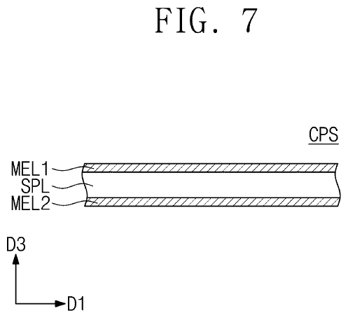

FIG. 7 is a cross-sectional view illustrating a composite substrate according to a comparative example of the present disclosure. Referring to FIG. 7, a composite substrate CPS may include a support layer SPL, and may also include a first metal layer MEL1 and a second metal layer MEL2 formed on opposite surfaces of the support layer SPL. The first metal layer MEL1 of the composite substrate CPS may be in contact with the first active material layer ACT1 of the first battery cell CEL1. The second metal layer MEL2 of the composite substrate CPS may be in contact with the first active material layer ACT1 of the second battery cell CEL2. Each, or at least one, of the first and second metal layers MEL1 and MEL2 of the composite substrate CPS may correspond to the current collector COL1 or COL2 discussed above with reference to FIG. 1.

The support layer SPL may include a polymer film. For example, the support layer SPL may include at least one of a polyethylene film, a polypropylene film, a polyvinylidene chloride film, or a multilayered film including a combination thereof.

Each, or at least one, of the first and second metal layers MEL1 and MEL2 may include at least one of aluminum, aluminum alloys, copper, copper alloys, nickel, nickel alloys, titanium, titanium alloys, iron, iron alloys, silver, and silver alloys.

In an example embodiment of the present disclosure, each, or at least one, of the first and second metal layers MEL1 and MEL2 may have a thickness of about 200 nm to about 5 μm. The support layer SPL may have a thickness of about 3 μm to about 10 μm. The thickness of the support layer SPL may be greater than the thickness of the first and second metal layers MEL1 and MEL2.

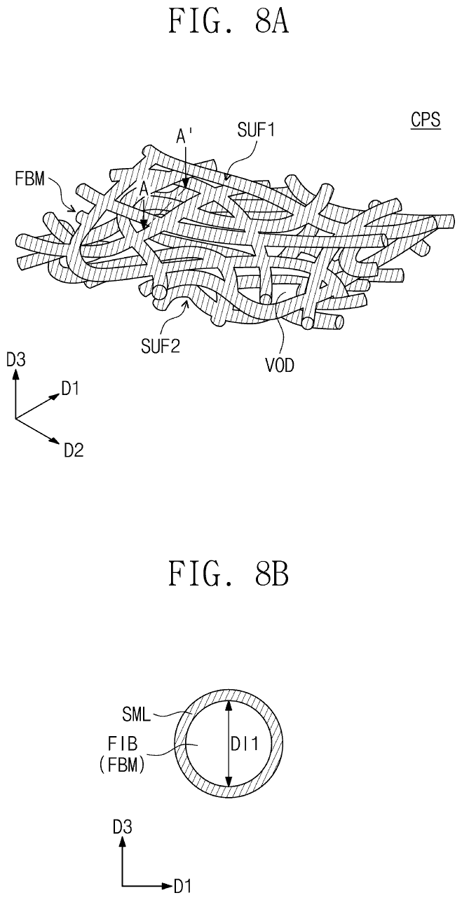

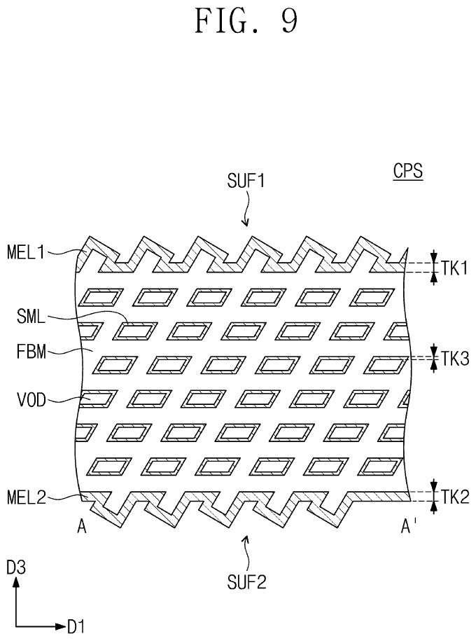

FIG. 8A is a perspective view illustrating a composite substrate according to an example embodiment of the present disclosure. FIG. 8B is a cross-sectional view illustrating a fiber of FIG. 8A. FIG. 9 is a cross-sectional view taken along line A-A′ of FIG. 8A, illustrating a composite substrate according to an example embodiment of the present disclosure.

Referring to FIGS. 8A, 8B, and 9, the composite substrate CPS according to some example embodiments may include a fiber mat layer FBM, and may also include a first metal layer MEL1 and a second metal layer MEL2 formed on opposite surfaces of the fiber mat layer FBM.

In an example embodiment, the fiber mat layer FBM may include a polymer fiber. The fiber mat layer FBM may have a fiber mat form and/or a non-woven fabric form. The fiber mat layer FBM may include a plurality of fibers FIB. The plurality of fibers FIB may be tangled to constitute the fiber mat layer FBM.

The fiber mat layer FBM may include voids VOD defined between the plurality of fibers FIB. In an example embodiment, the fiber mat layer FBM may include first fibers FIB1 that extend in a first direction D1, and second fibers FIB2 that extend in a second direction D2 that intersects the first direction D1. At least one first fiber FIB1 and at least one second fiber FIB2 may meet each other to define the void VOD.

In an example embodiment, the fiber mat layer FBM may include a polymer including at least one of polyethylene, polypropylene, polyvinylidene chloride, polyvinyl alcohol, polyimide, and polyethylene oxide. In another example embodiment, the fiber mat layer FBM may include at least one ceramic fiber including at least one of silicon oxide, alumina, manganese oxide, tin oxide, and barium titanate. For example, the fiber mat layer FBM may include a thermal insulating ceramic fiber. In this case, the composite substrate CPS may improve in thermal insulation performance. The ceramic fiber may be used alone or together with the polymer mentioned above to constitute the fiber mat layer FBM.

The fiber mat layer FBM may have a porosity of about 30% to about 70% or about 40% to about 60%. The porosity may be a ratio of the volume occupied by the voids VOD to the unit volume of the fiber mat layer FBM. The fiber mat layer FBM may have a larger porosity than the porosity of an ordinary polymer film. This may be caused by the fact that the fiber mat layer FBM is constituted by substantially tangled with fibers. As the fiber mat layer FBM has a small weight relative to volume, the battery may decrease in weight.

The fiber mat layer FBM may have a thickness of about 1 μm to about 5 μm in a third direction D3. The thickness of the fiber mat layer FBM may be less than the thickness of the support layer SPL according to a comparative example of FIG. 7. The fibers FIB of the fiber mat layer FBM may have an average diameter or a first diameter DI1, as illustrated in FIG. 8B. The first diameter DI1 may range from about 100 nm to about 500 nm.

As illustrated in FIG. 9, the first metal layer MEL1 may directly cover a top surface of the fiber mat layer FBM. The first metal layer MEL1 may be or include a coating layer that coats the top surface of the fiber mat layer FBM. The first metal layer MEL1 may cover protruding end portions of fibers FIB included in the fiber mat layer FBM. Thus, the composite substrate CPS may have an uneven profile of the first surface SUF1 defined by the first metal layer MEL1.

The second metal layer MEL2 may directly cover a bottom surface of the fiber mat layer FBM. The second metal layer MEL2 may be or include a coating layer that coats the bottom surface of the fiber mat layer FBM. The second metal layer MEL2 may cover protruding end portions of the fibers FIB included in the fiber mat layer FBM. Thus, the composite substrate CPS may have an uneven profile of the second surface SUF2 defined by the second metal layer MEL2.

Each, or at least one, of the first and second metal layers MEL1 and MEL2 may include at least one of aluminum, aluminum alloys, copper, copper alloys, nickel, nickel alloys, titanium, titanium alloys, iron, iron alloys, silver, and silver alloys.

The composite substrate CPS according to the example embodiment may further include a metal coating layer SML in the void VOD. The metal coating layer SML may cover a surface of the fiber FIB exposed by the void VOD. The metal coating layer SML may include the same or similar metal as the metal coating of the first and second metal layers MEL1 and MEL2.

The first metal layer MEL1 may have a first thickness TK1 in the third direction D3. The second metal layer MEL2 may have a second thickness TK2 in the third direction D3. The metal coating layer SML in the void VOD may have a third thickness TK3 in the third direction D3. In an example embodiment of the present disclosure, the first thickness TK1 may be greater than the third thickness TK3. The second thickness TK2 may be greater than the third thickness TK3. The first thickness TK1 and the second thickness TK2 may be substantially the same as each other. For example, each, or at least one, of the first thickness TK1 and the second thickness TK2 may range from about 500 nm to about 1 μm. The third thickness TK3 may range from about 100 nm to about 500 nm.

As discussed above, each, or at least one, of the first and second surfaces SUF1 and SUF2 of the composite substrate CPS may have an uneven profile. For example, each, or at least one, of the first surface SUF1 and the second surface SUF2 may have a relatively large surface roughness. Each, or at least one, of the first surface SUF1 and the second surface SUF2 may have a relatively large wettability, and may favorably adhere to any slurry that is coated thereon.

Each, or at least one, of the first surface SUF1 and the second surface SUF2 may have an average roughness (Sa) of about 1 μm to about 3 μm. As discussed above, the first thickness TK1 of the first metal layer MEL1 may range from about 500 nm to about 1 μm. For example, the average roughness of the first surface SUF1 may be greater than the first thickness TK1 of the first metal layer MEL1. A ratio of the average roughness of the first surface SUF1 to the first thickness TK1 of the first metal layer MEL1 may range from about 1 to about 6.

Each, or at least one, of the first surface SUF1 and the second surface SUF2 may have a water contact angle of about 1° to 45° or about 20° to about 40°. The water contact angle may be obtained with a contact angle analyzer, for example, Phoenix 300 commercially available from SEO (Surface Electro Optics). Each, or at least one, of the first and second surfaces SUF1 and SUF2 may have a relatively small water contact angle, and this may indicate that the first and second surfaces SUF1 and SUF2 may have high wettability. Therefore, when an active material layer is coated, slurry may satisfactorily adhere to the first and second surfaces SUF1 and SUF2.

The composite substrate CPS according to some example embodiments of the present disclosure may include the fiber mat layer FBM having a high porosity and a small thickness, and thus may achieve weight reduction. The metal coating layer SML may be formed within the void VOD of the fiber mat layer FBM, and thus the composite substrate CPS may have an increased electrical conductivity.

As each, or at least one, of the first and second surfaces SUF1 and SUF2 of the composite substrate CPS has a relatively large roughness, an increased adhesion force may be provided between the composite substrate CPS and an active material layer (e.g., the first active material layer ACT1 of FIG. 6) coated on the composite substrate CPS. It may be possible to reduce or prevent process defects such as, e.g., delamination or wrinkling the active material layer on the composite substrate CPS.

As the composite substrate CPS according to the present example embodiment has a high porosity, it may be possible to effectively reduce or suppress thermal conduction through the composite substrate CPS. In addition, even when a battery is fractured to cause a conductive substance to penetrate the composite substrate CPS, the fiber mat layer FBM may surround the conductive substance to reduce or prevent a fire due to short-circuits.

In the example embodiments that follow, a detailed description of technical features repetitive to those of the composite substrate mentioned above with reference to FIGS. 8A, 8B, and 9 will be omitted, and a difference thereof will be discussed in detail.

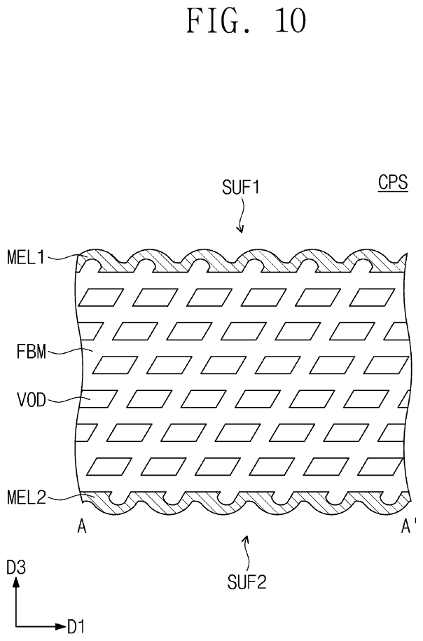

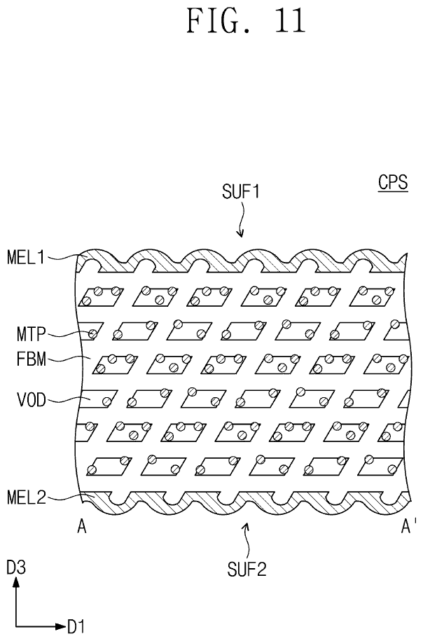

FIGS. 10 and 11 are cross-sectional views illustrating a composite substrate according to an example embodiment of the present disclosure. Referring to FIG. 10, a first metal layer MEL1 and a second metal layer MEL2 may be correspondingly formed on opposite surfaces of the fiber mat layer FBM.

The first metal layer MEL1 of the present example embodiment may have a thickness that is more uniform than the thickness of the first thickness TK1 of the first metal layer MEL1 depicted in FIG. 9. The first metal layer MEL1 of the present example embodiment may have a surface roughness that is less than the surface roughness of the first metal layer MEL1 depicted in FIG. 9. The first metal layer MEL1 of the example embodiment may have an uneven surface caused by protruding end portions of fibers included in the fiber mat layer FBM.

The second metal layer MEL2 of the present example embodiment may have a thickness that is more uniform than the thickness of the second thickness TK2 of the second metal layer MEL2 depicted in FIG. 9. The second metal layer MEL2 of the example embodiment may have a surface roughness that is less than the surface roughness of the second metal layer MEL2 depicted in FIG. 9. The second metal layer MEL2 of the example embodiment may have an uneven surface caused by protruding end portions of fibers included in the fiber mat layer FBM.

The fiber mat layer FBM may include a plurality of voids VOD. In an example embodiment, a metal coating layer SML may be omitted, or may not be formed, in the void VOD of the fiber mat layer FBM.

A method of manufacturing the composite substrate CPS according to the example embodiment may include forming a stack by interposing the fiber mat layer FBM between the first metal layer MEL1 and the second metal layer MEL2, and rolling the stack structure. In the method of manufacturing the composite substrate CPS according to the example embodiment, during a deposition process, the metal coating layer SML is not deposited in the void VOD.

Referring to FIG. 11, particles MTP, also referred to as functional particles MTP, may be additionally formed on the composite substrate CPS discussed in FIG. 10. The functional particles MTP may be dispersed in a matrix of the fiber mat layer FBM. In an example embodiment, during the formation of the fiber mat layer FBM, dual electrospinning may allow the functional particles MTP, along with a precursor of the fiber mat layer FBM, to constitute the fiber mat layer FBM. For example, at least one functional particle MTP may be formed in the void VOD of the fiber mat layer FBM.

In an example embodiment, the functional particles MTP may include at least one of conductive particles, particles including extinguishing materials, and particles including thermal insulating materials. For example, the conductive particles may include metal particles having a low resistivity. The particles including extinguishing materials may include a particle containing, e.g., a flame retardant material or an extinguishing agent. The particles including thermal insulting materials may include particles composed of materials having a low thermal conductivity.

The functional particles MTP may provide the fiber mat layer FBM with various functions or properties. The functional particles MTP may improve at least one of conductivity, flame resistance, stability, and thermal insulation of the fiber mat layer FBM. For example, when the functional particles MTP include metal particles, the composite substrate CPS according to the example embodiment may significantly improve in conductivity.

The functional particles MTP according to the example embodiment may be substantially identically applied to the composite substrate CPS of FIG. 9. In this case, the metal coating layer SML and the functional particle MTP may be present together within the void VOD of the fiber mat layer FBM.

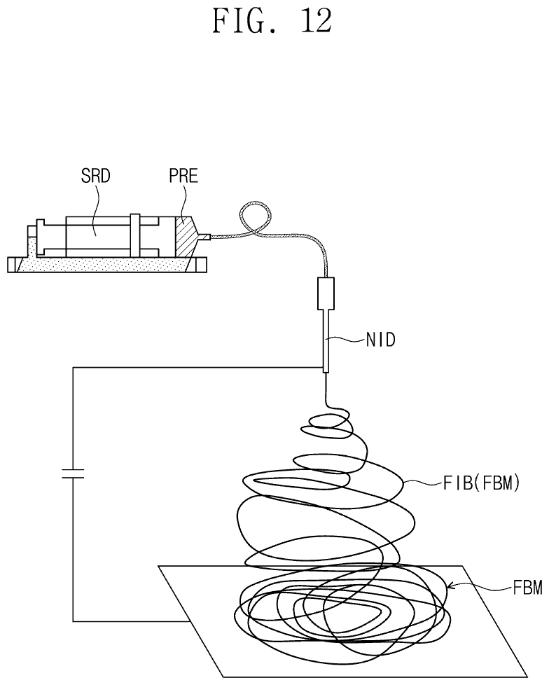

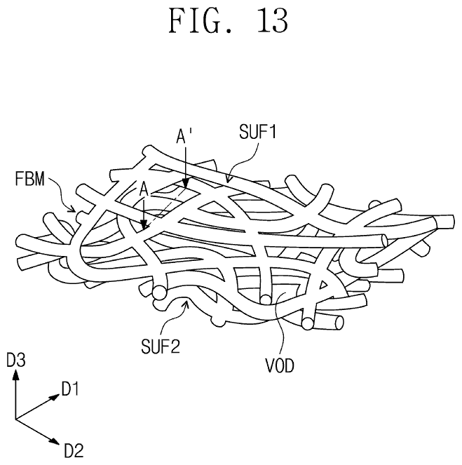

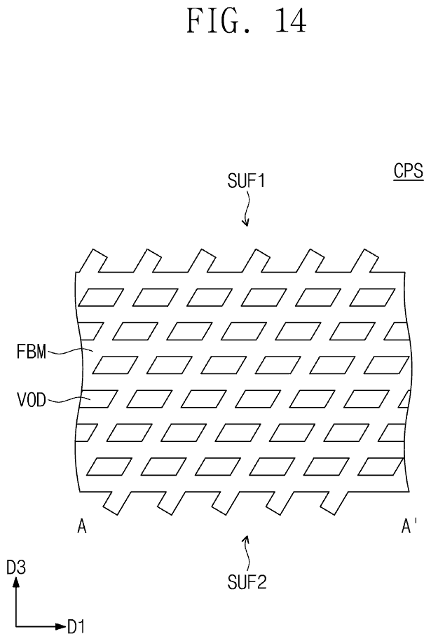

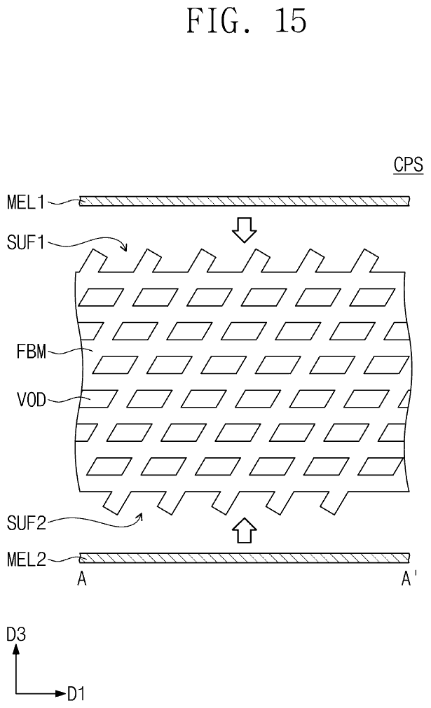

FIG. 12 is a conceptual diagram illustrating an electrospinning apparatus for manufacturing a fiber mat layer, according to an example embodiment of the present disclosure. FIG. 13 is a perspective view illustrating a fiber mat layer according to an example embodiment of the present disclosure. FIGS. 14 and 15 are cross-sectional views taken along line A-A′ of FIG. 13, illustrating a method of manufacturing a composite substrate according to an example embodiment of the present disclosure.

Referring to FIG. 12, a precursor PRE may be spun by, e.g., electrospinning, to form a fiber mat layer FBM. For example, the precursor PRE may be provided in a syringe SRD of an electrospinning apparatus. The precursor PRE may be or include a material for forming the fiber mat layer FBM of the present disclosure, and may be or include a solution including at least one polymer including at least one of polyethylene, polypropylene, and polyvinylidene chloride.

The syringe SRD may be configured to discharge the precursor PRE through a nozzle NID. An electric field generated from the nozzle NID may cause the precursor PRE to become a fiber FIB from the nozzle NID. The fiber FIB may be collected on a table in a fiber mat form. The collected fibers FIB may constitute the fiber mat layer FBM according to some example embodiments of the present disclosure.

FIG. 12 depicts, by way of example, the electrospinning process and equipment, and one of ordinary skill in the art can modify and use this process and equipment. In addition, as shown in FIG. 11, the functional particles MTP may be either spun with the fiber FIB, or mixed with the precursor PRE, to form the fiber mat layer FBM in which the functional particles MTP are dispersed.

FIGS. 13 and 14 depict, by way of example, the fiber mat layer FBM manufactured by the electrospinning process of FIG. 12. The fiber mat layer FBM may include voids VOD defined between a plurality of fibers FIB. The fiber mat layer FBM may have a first surface SUF1 and a second surface SUF2. The first surface SUF1 and the second surface SUF2 of the fiber mat layer FBM may respectively be a top surface and a bottom surface of the fiber mat layer FBM. A normal direction to each, or at least one, of the first and second surfaces SUF1 and SUF2 of the fiber mat layer FBM may be substantially parallel to the third direction D3.

Referring to FIG. 15, a first metal layer MEL1 may be formed on the first surface SUF1 of the fiber mat layer FBM. A second metal layer MEL2 may be formed on the second surface SUF2 of the fiber mat layer FBM. In an example embodiment of the present disclosure, each, or at least one, of the first and second metal layers MEL1 and MEL2 may have a thickness of about 500 nm to about 1 μm. The thickness of each, or at least one, of the first and second metal layers MEL1 and MEL2 may be less than the thickness of the fiber mat layer FBM.

The fiber mat layer FBM may be sandwiched between the first metal layer MEL1 and the second metal layer MEL2. A stack structure including the fiber mat layer FBM and the first and second metal layers MEL1 and MEL2 may be rolled to bind the first and second metal layers MEL1 and MEL2 to the fiber mat layer FBM. It may thus be possible to manufacture a composite substrate (see, e.g., composite substrate CPS of FIG. 10) according to an example embodiment of the present disclosure.

The composite substrate CPS of FIG. 9 according to an example embodiment of the present disclosure may be manufactured by performing a plating or deposition process on the fiber mat layer FBM illustrated in FIG. 14. In an example embodiment, since neither the plating process nor the deposition process uniformly forms metal on the fiber mat layer FBM, a thick first metal layer MEL1 and a thin metal coating layer SML may be concurrently formed on the fiber mat layer FBM as shown in FIG. 9.

The following description will focus on some example embodiments of the present disclosure. The following embodiments are provided to aid in understanding of the present disclosure and are not intended to limit the scope of the present disclosure.

### Example Embodiment 1

A precursor solution including polypropylene (PP) was electrically spun to form a fiber mat layer. The electrospinning was performed until the fiber mat layer an average thickness of the fiber mat layer reached about 3 μm.

The fiber mat layer was interposed between copper films. A thickness of each copper film was about 1 μm. A stack including the fiber mat layer and the copper films underwent a rolling process to manufacture a composite substrate. An average thickness of the composite substrate was about 5 μm.

### Example Embodiment 2

In the electrospinning process, a solution including copper particles, along with polypropylene fiber, was spun by dual spinning to form a fiber mat layer. Except that discussed above, a composite substrate was manufactured in the same method as in Example Embodiment 1.

### Comparative Example 1

A polyethylene terephthalate (PET) film having a thickness of 5 μm was prepared. A copper plating was performed on opposite surfaces of the PET film to manufacture a composite substrate. A first metal layer was formed to have a uniform thickness on a top surface of the PET film, and a second metal layer was formed to have a uniform thickness on a bottom surface of the PET film. Each of the first metal layer and the second metal layer was formed to have a thickness of about 1 μm.

### Comparative Example 2

A polyethylene terephthalate (PET) film having a thickness of 5 μm was prepared. A surface of the PET film was patterned to increase a surface roughness. For example, a texture roller was used to form a coarse surface of the PET film. Afterwards, the same method as in Comparative Example 1 was performed to manufacture a composite substrate.

### Evaluation 1: Surface Characteristics of Composite Substrate and Measure of Electrical Conductivity

The arithmetic average roughness (Sa) of each of the composite substrates according to Example Embodiments and Comparative Examples was measured. An electrical conductivity, a resistivity, and a water contact angle of each of the composite substrates according to Example Embodiments and Comparative Examples was measured. The results are listed in Table 1 below. The water contact angle was measured using Phoenix 300 commercially available from SEO (Surface Electro Optics). The measurement values were taken from two different surface areas, and an average was obtained.

TABLE 1

| | Surface roughness | | |
|---|---|---|---|
| | of metal layer | Resistivity | Water contact |
| | (Sa · μm) | (μΩ · cm) | angle |
| Example Embodiment | 2.1 | 0.42 | 31.4 |
| 1 | | | |
| Example Embodiment | 2.3 | 0.24 | 27.6 |
| 2 | | | |
| Comparative Example | 0.1 | 1.4 | 75.2 |
| 1 | | | |
| Comparative Example | 1.3 | 2.5 | 77.3 |
| 2 | | | |

Referring to Table 1, it may be observed that the composite substrates of Example Embodiment 1 and Example Embodiment 2 have high surface roughness, increased electrical conductivity, and desired or improved wettability. In contrast, it may be found that the composite substrates of Comparative Example 1 and Comparative Example 2 have low surface roughness, reduced electrical conductivity, and poor wettability. For example, the composite substrate according to the present disclosure has improved surface characteristics and increased electrical conductivity, compared to the composite substrate according to Comparative Examples.

### Evaluation 2: Surface Characteristics of Composite Substrate and Measure of Electrical Conductivity

Graphite powder (Japan carbon) and a binder were mixed in a weight ratio of 98:2 to prepare a negative electrode active material slurry. The binder was a mixture containing styrene butadiene rubber (SBR) and carboxymethyl cellulose (CMC) mixed in a weight ratio of 1:1.

The negative electrode active material slurry was coated at a level of 19.5 mg/cm² on the composite substrate of each of Example Embodiments and Comparative Examples. The coated electrode plate was dried at 100° C. for more than 1 hour, and then rolled to prepare a negative electrode having a mixture density of 1.66 g/cm³.

After a surface of the prepared negative electrode was cut and fixed to a slide glass, 180° peel strength was measured while delaminating the composite substrate and the results are shown in Table 2 below. A universal tensile strength machine (UTM) commercially available from INSTRON was used to measure the peel strength at five or more points was measured and to obtain an average value.

TABLE 2

| | Adhesion |
|---|---|
| | force |
| | (gf/mm) |
| Example Embodiment | 142 |
| 1 | |
| Example Embodiment | 147 |
| 2 | |
| Comparative Example | 98 |
| 1 | |
| Comparative Example | 112 |
| 2 | |

Referring to Table 2, the composite substrates of Example Embodiment 1 and Example Embodiment 2 have high surface roughness and wettability and thus a significantly improved or desired adhesion force to an active material layer. For example, the composite substrate according to the present disclosure may allow for the use of a smaller amount of binder when an electrode is coated, thereby increasing an energy density of the battery. The composite substrate according to examples of the present disclosure may reduce or prevent process defects such delamination of the active material layer in an electrode process.

A composite substrate according to examples of the present disclosure may have a small weight, a low thickness, and a high electrical conductivity. In addition, as the composite substrate has high surface roughness and wettability, an increased adhesion force may be provided between the composite substrate and an active material layer. When using the composite substrate according to examples of the present disclosure, it may be possible to reduce an amount of a binder in the active material layer and thus to increase an energy density of a rechargeable battery. The composite substrate according to examples of the present disclosure may effectively reduce or prevent the occurrence of short-circuit and fire even in case of damage.

Although some example embodiments of the present disclosure have been discussed with reference to accompanying figures, it will be understood that various changes in form and details may be made therein without departing from the spirit and scope of the present disclosure. It will be apparent to those skilled in the art that various substitution, modifications, and changes may be thereto without departing from the scope and spirit of the present disclosure.

What is claimed is:

1. A composite substrate for a rechargeable lithium battery, the composite substrate comprising:
a first metal layer;
a second metal layer; and
a fiber mat layer between the first metal layer and the second metal layer,
wherein the fiber mat layer includes:
a plurality of fibers; and
a plurality of voids between the plurality of fibers,
wherein the composite substrate has:
a first surface on which the first metal layer is formed; and
a second surface on which the second metal layer is formed,
wherein an average roughness (Sa) of the first surface is in a range of about 1 μm to about 3 μm.

2. The composite substrate of claim 1, wherein a porosity of the fiber mat layer is in a range of about 30% to about 70%.

3. The composite substrate of claim 1, wherein:
a first surface of the fiber mat layer includes protruding end portions of the fibers, and
the first metal layer directly covers the protruding end portions.

4. The composite substrate of claim 1, wherein:
a second surface of the fiber mat layer includes protruding end portions of the fibers, and
the second metal layer directly covers the protruding end portions.

5. The composite substrate of claim 1, wherein a water contact angle of the first surface of the composite substrate is in a range of about 20° to about 40°.

6. The composite substrate of claim 1, wherein:
a thickness of the first metal layer is less than a thickness of the fiber mat layer, and
a thickness of the second metal layer is less than the thickness of the fiber mat layer.

7. The composite substrate of claim 6, wherein:
the thickness of the first metal layer is in a range of about 500 nm to about 1 μm,
the thickness of the second metal layer is in a range of about 500 nm to about 1 μm, and
the thickness of the fiber mat layer is in a range of about 1 μm to about 5 μm.

8. The composite substrate of claim 1, wherein the fiber mat layer further comprises a plurality of particles in the voids.

9. The composite substrate of claim 8, wherein the particles comprise at least one of conductive particles, particles including extinguishing materials, and particles including thermal insulating materials.

10. The composite substrate of claim 1, wherein the fiber mat layer comprises at least one polymer including at least one of polyethylene, polypropylene, and polyvinylidene chloride.

11. The composite substrate of claim 1, further comprising a metal coating layer in at least one of the voids, wherein:
the first metal layer has a first thickness,
the second metal layer has a second thickness,
the metal coating layer has a third thickness,
the third thickness is less than the first thickness, and
the third thickness is less than the second thickness.

12. The composite substrate of claim 11, wherein the metal coating layer covers a surface of one of the plurality of fibers, the surface of one of the plurality of fibers being exposed through at least one void.

13. A rechargeable lithium battery, comprising:
a composite substrate that includes a first metal layer, a second metal layer, and a fiber mat layer between the first and second metal layers; and
a battery cell on the first metal layer,
wherein the fiber mat layer includes:
a plurality of fibers; and
a plurality of voids between the plurality of fibers,
wherein a porosity of the fiber mat layer is in a range of about 30% to about 70%.

14. The rechargeable lithium battery of claim 13, wherein the battery cell comprises:
a first active material layer on the first metal layer;
a separator on the first active material layer; and
a second active material layer on the separator.

15. The rechargeable lithium battery of claim 13, wherein:
a first surface of the fiber mat layer includes protruding end portions of the fibers, and
the first metal layer directly covers the protruding end portions.

16. The rechargeable lithium battery of claim 13, wherein:
a second surface of the fiber mat layer includes protruding end portions of the fibers, and
the second metal layer directly covers the protruding end portions.

17. The rechargeable lithium battery of claim 13, wherein:
a thickness of the first metal layer is in a range of about 500 nm to about 1 μm,
a thickness of the second metal layer is in a range of about 500 nm to about 1 μm, and
a thickness of the fiber mat layer is in a range of about 1 μm to about 5 μm.

18. A method of manufacturing a composite substrate, the method comprising:
electrospinning a precursor to form a fiber mat layer;
forming a stack structure in which the fiber mat layer is between a first metal layer and a second metal layer; and
rolling the stack structure.

19. The method of claim 18, wherein a porosity of the fiber mat layer is in a range of about 30% to about 70%.

20. The method of claim 18, wherein, after rolling the stack structure, an average roughness (Sa) of at least one of the first and second metal layers is in a range of about 1 μm to about 3 μm.
